(19) United States
(12) Patent Application Publication
(10) Pub. No.: US 2025/0187931 A1
(43) Pub. Date: Jun. 12, 2025

(54) SURFACE-TREATED SILICA POWDER, RESIN COMPOSITION, AND DISPERSION

(71) Applicant: TOKUYAMA CORPORATION, Yamaguchi (JP)

(72) Inventors: Satoshi WATANABE, Yamaguchi (JP); Keiji SAIKI, Yamaguchi (JP)

(21) Appl. No.: 18/843,874

(22) PCT Filed: Mar. 16, 2023
(86) PCT No.: PCT/JP2023/010244

§ 371 Date: Sep. 4, 2024

(30) Foreign Application Priority Data
Mar. 31, 2022 (JP) 2022-060287

(51) Int. Cl. C01B 33/18; C08K 3/36; C08K 9/02

(52) U.S. Cl. CPC C01B 33/18; C08K 3/36; C08K 9/02; C01P 2006/12; C08K 2201/006

(57) ABSTRACT

An aspect of the present invention provides surface-treated silica powder which is excellent in thickening property over time when used as a resin filler for a semiconductor sealant or the like. The surface-treated silica powder according to an embodiment of the present invention is surface-treated silica powder obtained by subjecting silica particles to surface treatment with use of a silica coupling agent. In the surface treated silica powder, a ratio (C/T) of an amount C of a silane coupling agent component chemically bonded to surfaces of the silica particles and an amount T of a silane coupling agent component present on the surface-treated silica powder is 0.7 or less.

### TECHNICAL FIELD

The present invention relates to surface-treated silica powder that can be suitably used as fillers, for example, for a semiconductor sealant, for a liquid crystal sealant, and for a film. The present invention also relates to a resin composition and a dispersion.

### BACKGROUND ART

In recent years, in accordance with enhanced performance and reduced size and weight of electronic devices, a form of a semiconductor package to be mounted is being improved to have higher integration, and a higher density and a smaller thickness. For practical application of such a semiconductor package, it is essential to design an integrated circuit and also to develop a sealant suitable for the design.

For example, although an epoxy resin is mainly used as an underfill agent to fill a gap between a semiconductor chip and a wiring substrate, the epoxy resin, the semiconductor chip, and the wiring substrate have respective coefficients of thermal expansion different one another. On this account, in a case where a connection part cannot absorb stress, a crack may be produced in the connection part. In order to reduce the occurrence of this crack, in the underfill agent, a filler, such as silica, which has a relatively small coefficient of thermal expansion is dispersed. In this case, in order to make the coefficient of thermal expansion of the sealant low, it is required to make a filling amount of a low-expansion-coefficient filler large. Further, the underfill agent filled with the filler is required to have a low viscosity immediately after filling and also temporal stability with which the viscosity will not increase over time after the filling.

In order to make the filling amount of the low-expansion-coefficient filler large, there has been proposed hydrophilic dry silica powder that has excellent dispersibility, has a small dispersed particle diameter, and has a narrow particle size distribution at the time of dispersion (Patent Literature 1). Unfortunately, since the silica powder disclosed in Patent Literature 1 has a small dispersed particle diameter, a viscosity-increasing effect of a resin composition is induced. Consequently, a resin composition which is filled with the silica powder disclosed in Patent Literature 1 has an increased viscosity, and thus may not be able to have a sufficient filling amount.

Further, there has been proposed a method for increasing affinity of silica particles with a resin by subjecting the silica particles to surface treatment with a silicon compound (for example, Patent Literature 2). The silica particles disclosed in Patent Literature 2 are uniformly surface-treated with a silicon compound, and a silicon compound that is not bonded to the surfaces of the particles is reduced. As a result, it is indicated that storage stability of the silica particles themselves are improved, and also, a low viscosity and a high flowability can be achieved at the time when the resin is filled. However, the following problem remains: although the affinity with the resin is improved by the surface treatment, a reactive hydroxyl group remaining on the surfaces of the particles acts on the resin over time and as a result, the viscosity increases and the flowability decreases.

### CITATION LIST

### Patent Literature

### [Patent Literature 1]

Japanese Patent Application Publication Tokukai No. 2014-152048

### [Patent Literature 2]

International Publication No. WO 2015/119283

### SUMMARY OF INVENTION

### Technical Problem

In light of the above, an object of an embodiment of the present invention is to provide surface-treated silica powder that is excellent in filling property and temporal stability. More specifically, it is an object of the present invention to provide surface-treated silica powder that makes it possible to obtain a resin composition having a high viscosity characteristic and a high temporal stability by improving affinity with a resin and providing a physical adsorption layer of a silane coupling agent on a silica powder surface.

### Solution to Problem

The inventors of the present invention have found that in a case where at a silica particle surface, a silane coupling agent is chemically bonded to the silica particle surface and a silane coupling agent component that is not chemically bonded is intentionally caused to be present in a large amount on the silica particle surface, a resin composition to which surface-treated silica powder in accordance with an embodiment of the present invention has been added can achieve an excellent viscosity characteristic and an excellent temporal stability since the resin is physically shielded from the reactive hydroxyl group on the silica particle surface.

In other words, the surface-treated silica powder in accordance with an embodiment of the present invention is surface-treated silica powder obtained by subjecting silica particles to surface treatment with use of a silica coupling agent, in a case where an amount, per specific surface area of the silica particles, of a silane coupling agent component chemically bonded to surfaces of the silica particles is C (molecules/nm²) and an amount, per specific surface area of the silica particles, of a silane coupling agent component present on the surface-treated silica powder is T (molecules/nm²), a ratio (C/T) of these silane coupling agent component amounts being 0.7 or less.

### Advantageous Effects of Invention

The surface-treated silica powder in accordance with an embodiment of the present invention can achieve both an excellent viscosity characteristic and an excellent temporal stability. This is because since the silane coupling agent physically adsorbed on the surfaces of the silica particles is present in a large amount in addition to the silane coupling agent chemically bonded to the surfaces of the silica particles, the resin composition to which the surface-treated silica powder has been added is not affected by a reactive hydroxyl group remaining on the silica particle surface. Therefore, the surface-treated silica powder is suitable as a filler for a semiconductor sealant and for a semiconductor mounting adhesive. Particularly, the surface-treated silica powder can be suitably used as a filler for a resin for high-density mounting.

### DESCRIPTION OF EMBODIMENTS

Surface-treated silica powder in accordance with the present invention will be described in detail below in accordance with embodiments of the present invention.

### [Surface-Treated Silica Powder]

Surface-treated silica powder in accordance with an embodiment of the present invention is surface-treated silica powder obtained by subjecting silica particles to surface treatment with use of a silica coupling agent, in a case where an amount, per specific surface area of the silica particles, of a silane coupling agent component chemically bonded to surfaces of the silica particles is C (molecules/nm²) and an amount, per specific surface area of the silica particles, of a silane coupling agent component present on the surface-treated silica powder is T (molecules/nm²), a ratio (C/T) of these silane coupling agent component amounts being 0.7 or less.

Here, in a case where the C/T is 0.7 or less, the silane coupling agent component physically adsorbed on the surfaces of the silica particles can physically shield a resin from a reactive hydroxyl group remaining on the surfaces of the silica particles. This makes it possible to achieve both an excellent viscosity characteristic and an excellent temporal stability. Particularly, a C/T of 0.6 or less is preferable. When the C/T exceeds 0.7, the reactive hydroxyl group of the silica particles reacts with the resin, and the temporal stability tends to deteriorate.

Further, the amount T of the silane coupling agent component on a surface-treated silica powder surface is preferably 2.0 molecules/nm² to 22.0 molecules/nm², and more preferably 4.0 molecules/nm² to 18.0 molecules/nm².

Here, in a case where the amount T of the silane coupling agent component is in 2.0 molecules/nm² to 22.0 molecules/nm², it is possible to sufficiently shield the resin from the reactive hydroxyl group on the silica particle surface. In a case where the amount T is less than 2.0 molecules/nm², affinity with an organic resin tends to decrease. On the other hand, in a case where the amount T exceeds 22.0 molecules/nm², the silane coupling agent fills a gap between the silica particles and consequently dispersibility at the time of filling tends to decrease.

The surface-treated silica powder has a BET specific surface area of preferably 1 m²/g to 100 m²/g, more preferably 2 m²/g to 80 m²/g, and even more preferably 5 m²/g to 50 m²/g. Here, in a case where the BET specific surface area of the surface-treated silica powder is 1 m²/g to 100 m²/g, it is possible to keep a viscosity of a resin composition low even when the resin is filled with a large amount of the surface-treated silica powder.

Here, in a case where the BET specific surface area is less than 1 m²/g, the viscosity of the resin composition which employs the surface-treated silica powder after surface treatment is low, but the silica particles have a diameter that is large relative to the gap. As a result, voids may be produced during gap permeation and may cause a molding defect. That is, sufficient narrow gap permeability may not be obtained. In a case where the BET specific surface area exceeds 100 m²/g, the resin composition may have a high viscosity and consequently, it may not be possible to obtain a sufficient filling amount of the filler.

Further, the amount of coarse particles of the surface-treated silica powder can be represented by V₉₀, which is calculated by the following expression:

$${V}_{90} = \{ ( {D}_{90} - {D}_{50} ) / {D}_{50} \} \times 100.$$

D₅₀: Cumulative 50 volume % diameter of a volume-based particle size distribution obtained by a laser diffraction scattering method.

D₉₀: Cumulative 90 volume % diameter of the volume-based particle size distribution obtained by the laser diffraction scattering method.

Here, the V₉₀ is preferably 10 or more and less than 100, more preferably 10 to 95, and even more preferably 20 to 90. When the V₉₀ is 10 or more and less than 100, a good gap permeability can be achieved when the resin composition is caused to permeate into the gaps. In a case where the V₉₀ is 100 or more, there are many coarse particles. As a result, voids may be produced during gap permeation, and may cause a molding defect. Accordingly, in a case where the V₉₀ is less than 10, industrial production may be difficult.

### [Applications]

Applications of the surface-treated silica powder in accordance with an embodiment of the present invention are not particularly limited. The surface-treated silica powder can be used as, for example, a filler for a semiconductor sealant or for a semiconductor mounting adhesive, a filler for a die attach film or for a die attach paste, or a filler for a resin composition such as an insulating film for a semiconductor package substrate. Particularly, the surface-treated silica powder obtained in an embodiment of the present invention can be suitably used as a filler for a resin composition for high-density mounting.

Further, the surface-treated silica powder obtained in accordance with an embodiment of the present invention can also be used as, for example, abrasive grains of chemical mechanical polishing (CMP) abrasives, abrasive grains for grind stones used for grinding etc., a toner external additive, an additive for liquid crystal sealants, a dental filler, and an inkjet coating agent.

### [Method for Producing Surface-Treated Silica Powder]

Next, the following will describe a method for producing surface-treated silica powder in accordance with an embodiment of the present invention.

A silane coupling agent is added to silica powder and mixed with the silica powder. By heating treatment, the silica particle surface and part of the coupling agent are reacted with (chemically bonded to) each other. As a result, obtained is treated powder in which both of a silane coupling agent component chemically bonded to the silica particle surface and a silane coupling agent component that is not chemically bonded are present. The treated powder thus obtained is dried, so that a by-product is removed. As a result, the surface-treated silica powder is obtained. The following will describe details.

### <Silica Powder>

The silica powder used in an embodiment of the present invention is desirably hydrophilic silica powder that has a BET specific surface area of 1 m²/g to 100 m²/g and a V₉₀ of 10 or more and less than 100.

Further, it is possible to use, as the silica powder, silica powder that includes silica particles which are surface-treated with a surface treatment agent other than the silane coupling agent, for example, another additive(s) such as hexamethyldisilazane. That is, by using the silica powder which has been surface-treated with the surface treatment agent, it is possible to obtain surface-treated silica powder which has various surface properties. For example, it is possible to easily obtain surface-treated silica powder constituted with use of a trimethylsilyl group and an epoxy group. Surface-treated silica powder constituted with use of different functional groups can have controlled affinity with a resin when the resin is filled with the surface-treated silica powder. As a result, a resin composition that achieves both of an excellent viscosity characteristic and an excellent temporal stability can be obtained.

### <Silane Coupling Agent>

Examples of the silane coupling agent include those represented by the following formula (1):

$${R}_{n} - Si - {X}_{( 4 - n )} \qquad ( 1 )$$

where: R is an organic group having 1 to 18 carbon atoms; X is a hydrolyzable group; and n is an integer of 1 to 3.

The X can be an alkoxy group having 1 to 3 carbon atoms such as a methoxy group, an ethoxy group, and a propoxy group, and/or a halogen atom such as a chlorine atom. Among those, a methoxy group and/or an ethoxy group are preferable. Note that, in a case where n is 1 or 2, a plurality of Xs may be the same each other or different from each other, but are preferably the same each other. Note that n is an integer of 1 to 3, but is preferably 1 or 2, and particularly preferably 1.

Examples of the silane coupling agent represented by the above formula (1) include methyltrimethoxysilane, ethyltriethoxysilane, hexyltrimethoxysilane, decyltrimethoxysilane, phenyltriethoxysilane, vinyltriethoxysilane, vinyltrimethoxysilane, 3-methacryloyloxypropyltrimethoxysilane, 3-methacryloyloxypropyltriethoxysilane, 3-acryloyloxytrimethoxysilane, 3-glycidoxypropyltrimethoxysilane, 3-glycidoxypropyltriethoxysilane, 3-aminopropyltrimethoxysilane, 3-aminopropyltriethoxysilane, N-(2-aminoethyl)-3-aminopropyltrimethoxysilane, N-(2-aminoethyl)-3-aminopropylmethyldimethoxysilane, N-phenyl-3-aminopropyltrimethoxysilane, N,N-dimethyl-3-aminopropyltrimethoxysilane, N,N-diethyl-3-aminopropyltrimethoxysilane, and 4-styryltrimethoxysilane.

### <Surface Treatment Agent (Another Additive(s))>

In addition to the silane coupling agent, at least one surface treatment agent selected from the group consisting of silicone oil, siloxanes, and/or silazanes may be added. The surface treatment agent may be added simultaneously with the silane coupling agent, or the silane coupling agent may be added after addition of the surface treatment agent. Further, the surface treatment agent may be added after addition of the silane coupling agent. This provides surface-treated silica powder that has various surface properties. For example, it is possible to easily obtain surface-treated silica powder constituted with use of a trimethylsilyl group and an epoxy group.

In a case where silicone oil is used as the surface treatment agent, the amount of the surface treatment agent to be used is preferably 0.05 parts by mass to 80 parts by mass, more preferably 0.1 parts by mass to 60 parts by mass, and most preferably 1 part by mass to 20 parts by mass, relative to 1 part by weight of the silica powder. Similarly, in a case where a siloxane is used as the surface treatment agent, the amount of the siloxane is preferably 0.001 parts by mass to 40 parts by mass, more preferably 0.003 parts by mass to 30 parts by mass, and most preferably 0.005 parts by mass to 20 parts by mass, relative to 1 part by weight of the silica powder. Similarly, in a case where a silazane is used as the surface treatment agent, the amount of the siloxane is preferably 0.001 parts by mass to 40 parts by mass, more preferably 0.003 parts by mass to 30 parts by mass, and most preferably 0.005 parts by mass to 20 parts by mass, relative to 1 part by weight of the silica powder.

### <Mixing>

The silica powder and the silane coupling agent are mixed with each other by a conventionally known method. For example, the silica powder is placed in a mixing vessel, and a predetermined amount of the silane coupling agent is added by, for example, dropping or spraying in a state in which the silica powder is fluidized by, for example, shaking or stirring. For example, silica powder is added to a vessel, and stirring by rotation of a stirring blade is started. Then, a silane coupling agent is added to the vessel with use of a peristaltic pump. An addition rate of the silane coupling agent can be changed as appropriate according to the amount of the silane coupling agent to be added.

It is preferable that stirring be continued for 10 minutes or longer after the addition of the silane coupling agent. By continuing stirring, it is possible to cause the silane coupling agent to uniformly adhere to the silica powder surface. This makes it possible to reduce the silane coupling agent physically adsorbed on the surface-treated silica powder surface.

Examples of the mixing vessel include: a Henschel mixing apparatus, a Loedige mixer, and the like in which a stirring blade, a mixing blade, or the like is provided; an air blender and the like which perform air flow mixing with use of air; and a V-blender, a double-cone mixing apparatus, a rocking mixer, and the like in which mixing is carried out by rotation or swinging of a vessel body.

### <Heating Treatment>

By carrying out the heating treatment, part of the silane coupling agent added is reacted with (i.e., chemically bonded to) the silica particle surface. Further, a remaining silane coupling agent is allowed to remain (i.e., physically adsorbed) on the silica particle surface without being chemically bonded. With regard to a temperature at which the heating treatment is carried out, in the case of a low temperature, the reaction proceeds slowly and thus efficiency of production is decreased. On the other hand, in the case of a high temperature, decomposition of the silane coupling agent and the surface treatment agent and formation of an aggregate due to a rapid polymerization reaction are accelerated. Thus, the temperature at which the heating treatment is carried out is generally 25° C. to 300° C., and preferably 40° C. to 250° C., depending on the surface treatment agent and/or the like to be used.

A heating treatment time may be determined as appropriate according to the reactivity of the surface treatment agent and/or the like to be used. Typically, a sufficient reaction rate can be achieved within 1 hour to 500 hours.

Further, in a case where the heating treatment can be carried out in the mixing vessel used for mixing, mixed powder may be used as is for the heating treatment in the apparatus.

### <Drying Treatment>

Drying temperature is not particularly limited. However, a high temperature is not preferable because a silane coupling agent component (physically adsorbed) that exists without being chemically bonded is volatilized and is removed from the silica powder. On the other hand, a low temperature cannot sufficiently remove a by-product. Thus, the drying temperature is preferably 25° C. to 200° C., more preferably 25° C. to 180° C., and more preferably 25° C. to 150° C. Drying at 25° C. or higher makes it possible to sufficiently remove a by-product formed at the time when the silane coupling agent reacts with the silica particle surface.

An apparatus used for drying is not particularly limited, and a conventionally known drying apparatus can be used. Further, in a case where drying is possible in the reaction vessel used for the heating treatment, the treated powder may be provided as is for drying treatment in the apparatus.

The pressure inside the apparatus at the time of drying is preferably a pressure equal to or higher than atmospheric pressure. More specifically, the pressure is preferably 1000 hPa or higher. Drying at a pressure higher than the atmospheric pressure makes it possible to sufficiently remove an unreacted silane coupling agent. In a case where the pressure is 1000 hPa or higher, the by-product can be sufficiently removed without volatilizing the silane coupling agent component that has been physically adsorbed.

A drying time is not particularly limited and may be chosen as appropriate depending on drying conditions including, for example, the drying temperature and pressure. In general, in a case where the drying time is approximately 1 hour to 48 hours, surface-treated silica powder from which the by-product is removed can be obtained.

### [Dispersion]

The surface-treated silica powder in accordance with an embodiment of the present invention can be dispersed in a solvent in liquid form to form a dispersion. The solvent used for dispersing the surface-treated silica powder is not particularly limited as long as the solvent is a solvent in which the surface-treated silica powder can be easily dispersed.

As such a solvent, for example, water and organic solvents such as alcohols, ethers, and ketones can be used. Examples of the alcohols include methanol, ethanol, and 2-propyl alcohol. As the solvent, a mixed solvent of water and any one or more of the above organic solvents may be used. Note that in order to improve the stability and dispersibility of the surface-treated silica powder, various additives may be added, including a dispersant such as a surfactant, a thickener, a wetting agent, a defoaming agent, and an acidic or alkaline pH adjusting agent. Further, the pH of the dispersion is not limited.

Examples of an application of the dispersion include application to filling of a semiconductor sealant and a semiconductor mounting adhesive. In a case where the dispersion is, namely, surface-treated silica powder dispersed in a solvent in advance, the dispersion is easily dispersed in a resin. For example, removing the solvent after mixing the resin and the dispersion with each other, it is possible to easily prepare an underfill agent in which a filler is dispersed well.

### [Resin Composition]

A type of resin to which the surface-treated silica powder is blended for producing the resin composition in accordance with an embodiment of the present invention is not particularly limited. The type of the resin may be selected as appropriate depending on a desired application, and examples thereof include epoxy resin, acrylic resin, silicone resin, olefin-based resin, polyimide resin, and/or polyester-based resin.

As a method for producing the resin composition, a known method may be employed as appropriate, and surface-treated silica powder may be mixed with various resins and other components to be blended as necessary.

When such a dispersion in accordance with an embodiment of the present invention is mixed with the resin, a resin composition containing the silica powder in a better dispersion state in the resin can be obtained than when dried silica powder is mixed with the resin. The better dispersion state of particles means fewer aggregated particles in the resin composition. This enables the resin composition containing the surface-treated silica powder in accordance with an embodiment of the present invention as a filler to have further improved performance in terms of both the viscosity characteristic and the gap permeability.

The resin composition can be applied as, for example, a semiconductor sealant and a semiconductor mounting adhesive. Since the resin composition containing the surface-treated silica powder can suppress a coefficient of thermal expansion, the resin composition is suitable for such applications.

Aspects of the present invention can also be expressed as follows:

As understood from the above description, surface-treated silica powder in accordance with a first aspect of the present invention is surface-treated silica powder obtained by subjecting silica particles to surface treatment with use of a silica coupling agent, in a case where an amount, per specific surface area of the silica particles, of a silane coupling agent component chemically bonded to surfaces of the silica particles is C (molecules/nm²) and an amount, per specific surface area of the silica particles, of a silane coupling agent component present on the surface-treated silica powder is T (molecules/nm²), a ratio (C/T) of these silane coupling agent component amounts being 0.7 or less.

According to this surface-treated silica powder, the silane coupling agent physically adsorbed on the surfaces of the silica particles is present in a large amount in addition to the silane coupling agent chemically bonded to the surfaces of the silica particles. Accordingly, a resin composition to which the surface-treated silica powder in accordance with the first aspect of the present invention has been added can achieve both an excellent viscosity characteristic and an excellent temporal stability.

Surface-treated silica powder in accordance with a second aspect of the present invention is configured such that in the surface-treated silica powder in accordance with the first aspect described above, the amount T of the silane coupling agent component is 2.0 molecules/nm² to 22.0 molecules/nm².

Surface-treated silica powder in accordance with a third aspect of the present invention is configured such that in the surface-treated silica powder in accordance with the first or second aspect described above, an amount (V₉₀) of coarse particles of the surface-treated silica powder, which is obtained by expression 1 from a cumulative 50 volume % diameter (D₅₀) and a cumulative 90 volume % diameter (D₉₀) of a volume-based particle size distribution obtained by a laser diffraction scattering method, is 10 or more and less than 100:

$${V}_{90} = \{ ( {D}_{90} - {D}_{50} ) / {D}_{50} \} \times 100. \qquad ( 1 )$$

Surface-treated silica powder in accordance with a fourth aspect of the present invention is configured to have a BET specific surface area of 1 m²/g to 100 m²/g in the surface-treated silica powder in accordance with any one of the first to third aspects described above.

A resin composition according to a fifth aspect of the present invention is obtained by dispersing, in a resin, the surface-treated silica powder in accordance with any one of the first to fourth aspects described above.

A dispersion according to a sixth aspect of the present invention is obtained by dispersing, in a solvent in liquid form, the surface-treated silica powder in accordance with any one of the first to fourth aspects described above.

### EXAMPLES

The following will specifically describe embodiments of the present invention based on Examples in the embodiments of the present invention. Note, however, that embodiments of the present invention are not limited by these Examples.

Measurements and evaluations of physical properties of silica powder and surface-treated silica powder are performed by the following methods.

### (Method of Determining C/T)

1) Surface-treated silica powder was suspended in ethanol so as to make a concentration of 3% by mass, so that 30 ml in total volume of a suspension was obtained. The suspension was placed in a centrifuge tube (Violamo centrifuge tube II 50 mL, manufactured by AS ONE CORPORATION), and then subjected to dispersion for 10 minutes in a desktop ultrasonic cleaner (M2800-J (output: 110 W; oscillation frequency: 40 kHz), which is manufactured by BRANSON and which is one example of an ultrasonic disperser). A dispersion slurry 1 was thus obtained.
2) The centrifuge tube containing the dispersion slurry 1 was put in a centrifuge (CN-1050, manufactured by AS ONE CORPORATION) at 5000 rpm for 30 minutes. Subsequently, supernatant liquid separated in an upper layer was removed, and a sedimentation cake was obtained in the centrifuge tube (solid-liquid separation).
3) Ethanol was added to the centrifuge tube in the above 2) so that a total volume became 30 mL. A resultant mixture was subjected to dispersion as in the above 1) for 10 minutes. As a result, a dispersion slurry 2 was obtained.
4) The above 2) and 3) were repeated three times in total, and a cake 1 obtained in a third time 2) was dried in vacuum (MVD-100, a molding vacuum desiccator manufactured by AS ONE CORPORATION, and a dry vacuum pump manufactured by AS ONE CORPORATION) for 1 hour at room temperature. As a result, cleaned powder was obtained.
5) With use of respective amounts of carbon (described later) in the surface-treated silica powder and in the cleaned powder, the BET specific surface area (described later) of the silica powder (i.e., non-surface-treated powder), and the number of carbon atoms (no unit) in the silane coupling agent, an amount C (molecules/nm²) of a chemically bonded component and an amount T (molecules/nm²) of a silane coupling agent component were calculated by the following formulae:

$$T ( molecules / {nm}^{2} ) = amount ( mass \% ) of carbon \\ \\ \\ in surface - treated silica \\ \\ \\ ( i . e . , non - cleaned powder ) / 100 / 12 ( atomic mass of carbon ) / \\ \\ \\ \{ number of Avogadro constant ( molecules / mol ) / \\ BET specific surface area of silica powder ( {m}^{2} / g ) / {10}^{18} ; and$$

$$C ( molecules / {nm}^{2} ) = amount ( mass \% ) of \\ \\ \\ carbon in cleaned powder / 100 / 12 ( atomic mass of carbon ) / \\ \\ \\ \{ number of carbon atoms in silane \\ coupling agent - N \} \times number of Avogadro constant ( molecules / mol ) / \\ \\ \\ BET specific surface area of silica powder ( {m}^{2} / g ) / {10}^{18} .$$

(In the above formulae, the number of carbon atoms in the silane coupling agent is equal to the number of carbon atoms in the molecular formula of the silane coupling agent to be used. For example, in a case where KBM-403 manufactured by Shin-Etsu Silicones is used, the number of carbon atoms in the silane coupling agent is 9 because the silane coupling agent has a molecular formula C₉H₂₀O₅Si. N is (the number of carbon atoms in a hydrolysis group X in the silane coupling agent)×2. For example, in a case where X is a methoxy group, N is 2, and in a case where X is an ethoxy group, N is 4. The Avogadro constant is 6.02×10²³ (molecules/mol).)
6) From the C and T, a ratio (C/T) of the amount T of the silane coupling agent component on the surface of the surface-treated silica powder and the amount C of the chemically bonded component was calculated.
T: Total amount of silane coupling agent per unit area of surface-treated silica powder
C: Amount of chemically bonded silane coupling agent per unit area of surface-treated silica powder

### (Amount of Carbon)

The amount (mass %) of carbon was measured by a measurement device for total nitrogen and total carbon (SUMIGRAPH NC-22F, manufactured by Sumika Chemical Analysis Service, Ltd.). Note that an amount of the measured silica sample was 50 mg to 100 mg.

### (BET Specific Surface Area)

The BET specific surface area S (m²/g) was measured by the nitrogen adsorption BET one-point method using a specific surface area measuring device (SA-1000, manufactured by Shibata Rikagaku Co., Ltd.).

### (Volume-Based Particle Size Distribution by Laser Diffraction Scattering Method)

Approximately 0.1 g of surface-treated silica powder was weighed out in a 50-mL glass bottle with use of an electronic balance. Approximately 40 ml of ethanol was added, and the surface-treated silica powder was dispersed with use of an ultrasonic homogenizer (Sonifier 250, manufactured by BRANSON) under conditions of 40 W and 10 minutes. Subsequently, an average particle diameter (nm) and a coefficient of variation of the surface-treated silica powder were measured with use of a laser diffraction scattering method-based particle size distribution measurement device (LS 13 320, manufactured by Beckman Coulter, Inc.). The average particle diameter (nm) herein means a volume-based cumulative 50% diameter. A cumulative 50 volume % diameter (D₅₀) and a cumulative 90 volume % diameter (D₉₀) were calculated from the volume-based particle size distribution obtained. From the D₅₀ and D₉₀ thus obtained, an amount (V₉₀) of coarse particles of the surface-treated silica powder was obtained. The amount (V₉₀) was obtained by expression 1.

$${V}_{90} = \{ ( {D}_{90} - {D}_{50} ) / {D}_{50} \} \times 100 \qquad ( 1 )$$

### (Evaluation of Dispersibility of Surface-Treated Silica Powder)

With respect to a mixture of 17 g of bisphenol F-type epoxy resin (YDF-8170C, manufactured by NIPPON STEEL CHEMICAL & MATERIAL CO., LTD.) and 7 g of amine hardener (KARAHARD A-A, manufactured by Nippon Kayaku Co., Ltd.), 36 g of surface-treated silica powder was added, and a resultant mixture was kneaded by hand. A hand-kneaded resin composition was pre-kneaded with use of a rotation-revolution mixer (Awatori Rentaro AR-500, manufactured by THINKY CORPORATION) (kneading: 1000 rpm, 8 minutes; defoaming: 2000 rpm, 2 minutes). A pre-kneaded resin composition was stored in a constant temperature water bath at 25° C. and then kneaded with use of a three roll mill (BR-150HCV, manufactured by AIMEX CO., LTD., roll diameter of 63.5). The kneading was performed under the conditions that a kneading temperature was 25° C., a roll-to-roll distance was 20 μm, and the number of times of kneading was eight times. The resin composition thus obtained was defoamed for 30 minutes under reduced pressure with use of a vacuum pump (TSW-150 manufactured by SATO VAC INC.).

The kneaded resin composition was measured for initial viscosity (η₁) and viscosity after 1 day (η₂) at a shear rate of 1s⁻¹ with use of a rheometer (HAAKE MARS40, manufactured by Thermo Fisher Scientific Inc.). Note that a measurement temperature was 25° C., and a sensor used was C35/1 (cone plate type; diameter of 35 mm; angle: 1 degree; material: titanium). Here, the resin composition was stored at 25° C.

The viscosity (η₁) at the preparation of the resin composition and the viscosity (η₂) after 1 day were used for calculation of a rate of change in viscosity over time. The rate of change was calculated by the following expression:

$$Rate of change in viscosity over time [ \% ] = \{ ( {η}_{2} - {η}_{1} ) / {η}_{1} \} \times 100$$

In a case where the rate of change in viscosity over time was 100% or less, a thickening index was determined to be good. On the other hand, in a case where the rate of change in viscosity over time was more than 100%, the thickening index was determined to be poor. Here, in a case where the thickening index is good, the surface-treated silica powder is considered be excellent in viscosity characteristic and temporal stability.

### (Gap Permeability Evaluation)

Two sheets of glass were stacked in advance with a gap of 30 μm provided therebetween. With the sheets of glass heated to 110° C., a high temperature penetration test was performed on the kneaded resin compositions prepared in (5) (at the preparation). The presence or absence of a flow mark was evaluated by visual observation of the appearance. In a case where a flow mark was absent, the gap permeability was determined to be good. On the other hand, in a case where a flow mark was present, the gap permeability was determined to be poor. Here, in a case where the gap permeability is good, the surface-treated silica powder is considered to be excellent in filling property and viscosity characteristic.

### Example 1

Silica powder A shown in Table 1 was introduced into a mixing vessel, and stirring was started. Then, 1.5 parts by mass of a silane coupling agent (KBM-403, manufactured by Shin-Etsu Silicones) was fed to 100 parts by mass of the silica powder A with use of a peristaltic pump (SJ-1211 II-H, manufactured by ATTA CORPORATION). After the above feed, stirring was continued, and mixing was carried out for 15 minutes. After the mixing, while the stirring was still continued, the temperature was increased from room temperature to 40° C. in 20 minutes. The temperature was then maintained at 40° C. for 60 minutes. Thereafter, the temperature was increased to 100° C. in 60 minutes, and was then maintained at 100° C. for 180 minutes, so that a reaction step was finished. After the reaction step was finished, cooling was carried out, and nitrogen was circulated in the vessel and drying was carried out while the temperature was maintained at 30° C. As a result, surface-treated silica powder was obtained. Table 1 shows properties of the silica powder and conditions for preparation of the surface-treated silica powder, and Table 2 shows physical properties of the surface-treated silica powder (hereinafter, the same will apply).

TABLE 1

| | Silica powder | | | | | | | Surface | | | | | | |
|---|---|---|---|---|---|---|---|---|---|---|---|---|---|---|
| | | Specific | | | | Coupling agent | | treatment agent | | | | | | |
| | | Surface | | | | | Amount | | Amount | Heating treatment | | Drying treatment | | |
| | Type | Area | D₉₀ | D₅₀ | V₉₀ | Type | used | Type | used | Temperature | Time | Pressure | Temperature | Time |
| | Unit | | | | | | | | | | | | | |
| | | | | | | | parts by | | parts by | | | | | |
| Item | | m²/g | nm | nm | % | — | mass | — | mass | ° C. | Hr | hPa | ° C. | Hr |
| Example 1 | A | 9 | 527 | 385 | 37 | KBM-403 | 1.5 | — | — | 100 | 3 | 1030 | 30 | 12 |
| Example 2 | B | 15 | 350 | 240 | 46 | KBM-403 | 2.5 | — | — | 150 | 3 | 1030 | 30 | 12 |
| Example 3 | C | 50 | 140 | 96 | 46 | KBM-403 | 8.0 | — | — | 100 | 3 | 1030 | 30 | 12 |
| Example 4 | D | 3 | 1560 | 1080 | 44 | KBM-403 | 0.5 | SZ-31 | 0.01 | 100 | 3 | 1030 | 50 | 12 |
| Example 5 | E | 3 | 1500 | 1010 | 49 | KBM-403 | 0.5 | — | — | 100 | 3 | 1030 | 30 | 12 |
| Example 6 | D | 3 | 1560 | 1080 | 44 | KBM-403 | 1 | SZ-31 | 0.01 | 100 | 3 | 1030 | 50 | 12 |
| Example 7 | D | 3 | 1560 | 1080 | 44 | KBM-403 | 2 | SZ-31 | 0.01 | 100 | 3 | 1030 | 50 | 12 |
| Example 8 | D | 3 | 1560 | 1080 | 44 | KBM-573 | 0.5 | — | — | 100 | 3 | 1030 | 30 | 12 |
| Example 9 | D | 3 | 1560 | 1080 | 44 | KBM-303 | 0.5 | SZ-31 | 0.01 | 100 | 3 | 1030 | 50 | 12 |
| Example 10 | D | 3 | 1560 | 1080 | 44 | KBM-503 | 0.5 | SZ-31 | 0.01 | 100 | 3 | 1030 | 50 | 12 |
| Example 11 | D | 3 | 1560 | 1080 | 44 | KBM-403 | 0.5 | SZ-31 | 0.02 | 100 | 3 | 1030 | 50 | 12 |
| Comparative | A | 9 | 527 | 385 | 37 | — | — | — | — | 150 | 3 | 20 | 50 | 1 |
| Example 1 | | | | | | | | | | | | | | |
| Comparative | A | 9 | 527 | 385 | 37 | KBM-403 | 0.75 | — | — | 100 | 3 | 20 | 50 | 1 |
| Example 2 | | | | | | | | | | | | | | |
| Comparative | A | 9 | 527 | 385 | 37 | KBM-403 | 0.5 | — | — | 100 | 3 | 20 | 50 | 1 |
| Example 3 | | | | | | | | | | | | | | |
| Comparative | A | 9 | 527 | 385 | 37 | KBM-403 | 0.5 | — | — | — | — | 1030 | 50 | 12 |
| Example 4 | | | | | | | | | | | | | | |
| Comparative | A | 9 | 527 | 385 | 37 | KBM-403 | 9 | — | — | 100 | 3 | 1030 | 50 | 12 |
| Example 5 | | | | | | | | | | | | | | |
| Comparative | A | 9 | 527 | 385 | 37 | KBM-403 | 18 | — | — | 150 | 3 | 1030 | 50 | 12 |
| Example 6 | | | | | | | | | | | | | | |

Silica powder A: SILFIL NSS-40D, manufactured by Tokuyama Corporation
Silica powder B: SILFIL NSS-24D, manufactured by Tokuyama Corporation
Silica powder C: SILFIL NSS-5N, manufactured by Tokuyama Corporation
Silica powder D: SANSIL SS-10, manufactured by Tokuyama Corporation
Silica powder E: HMDS-treated product of SANSIL SS-10 (amount of TMS equivalent to 0.5 molecules/nm²), manufactured by Tokuyama Corporation

TABLE 2

| | Surface-treated silica powder | | | | | | | | |
|---|---|---|---|---|---|---|---|---|---|
| | | | | | Silane | Chemically | | | |
| | Specific | | | | coupling agent | bonded | | | |
| | Surface | | | | component | component | | Thickening | Gap |
| | Area | D₉₀ | D₅₀ | V₉₀ | amount T | amount C | C/T | index | permeability |
| | Unit | | | | | | | | |
| Item | m²/g | nm | nm | % | molecules/nm² | molecules/nm² | — | — | — |
| Example 1 | 8 | 515 | 373 | 38 | 4.2 | 2.1 | 0.5 | Good | Good |
| Example 2 | 14 | 315 | 201 | 57 | 4.2 | 2.2 | 0.5 | Good | Good |
| Example 3 | 50 | 211 | 122 | 73 | 4.2 | 2.2 | 0.5 | Good | Good |
| Example 4 | 2 | 1582 | 1049 | 51 | 3.9 | 2.2 | 0.6 | Good | Good |
| Example 5 | 2 | 1695 | 1076 | 58 | 4.3 | 2.6 | 0.6 | Good | Good |
| Example 6 | 2 | 1764 | 1100 | 60 | 6.6 | 2.4 | 0.4 | Good | Good |
| Example 7 | 2 | 1641 | 1108 | 48 | 15.4 | 2.6 | 0.2 | Good | Good |
| Example 8 | 2 | 1582 | 1090 | 45 | 4.2 | 2.6 | 0.6 | Good | Good |
| Example 9 | 2 | 1668 | 1100 | 52 | 4.2 | 2.2 | 0.5 | Good | Good |
| Example 10 | 2 | 1669 | 1092 | 53 | 4.2 | 2.1 | 0.5 | Good | Good |
| Example 11 | 2 | 1544 | 1058 | 46 | 4.3 | 2.6 | 0.6 | Good | Good |
| Comparative | 9 | 522 | 383 | 36 | 0.0 | 0.0 | — | Poor | Poor |
| Example 1 | | | | | | | | | |
| Comparative | 8 | 474 | 362 | 31 | 2.1 | 1.9 | 0.9 | Poor | Good |
| Example 2 | | | | | | | | | |
| Comparative | 8 | 473 | 360 | 31 | 1.5 | 1.5 | 1.0 | Poor | Poor |
| Example 3 | | | | | | | | | |
| Comparative | 8 | 522 | 360 | 45 | 1.5 | 0.2 | 0.1 | Good | Poor |
| Example 4 | | | | | | | | | |
| Comparative | 8 | 472 | 363 | 30 | 25.0 | 2.0 | 0.1 | Good | Poor |
| Example 5 | | | | | | | | | |
| Comparative | 8 | 989 | 363 | 172 | 49.0 | 2.2 | 0.0 | Good | Poor |
| Example 6 | | | | | | | | | |

### Example 2

5 Silica powder B was introduced into a mixing vessel, and stirring was started. Then, 2.5 parts by mass of a silane coupling agent (KBM-403, manufactured by Shin-Etsu Silicones) was fed to 100 parts by mass of the silica powder B with use of a peristaltic pump (SJ-1211 II-H, manufactured by ATTA CORPORATION). After the above feed, stirring was continued, and mixing was carried out for 15 minutes. After the mixing, while the stirring was still continued, the temperature was increased from room temperature to 40° C. in 20 minutes. The temperature was then maintained at 40° C. for 60 minutes. After that, the temperature was increased to 150° C. in 60 minutes, and was then maintained at 150° C. for 180 minutes, so that a reaction step was finished. Thereafter, surface-treated silica powder was prepared and measured in Example 1.

### Example 3

Surface-treated silica powder was prepared and measured as in Example 1, except that: silica powder C was used, instead of silica powder A; and 8.0 parts by mass of KBM-403 was used as the silane coupling agent, relative to 100 parts by mass of the silica powder C.

### Example 4

Silica powder D was introduced into a mixing vessel, and stirring was started. Then, 0.01 parts by mass of hexamethyldisilazane (SZ-31, manufactured by Shin-Etsu Silicones, Ltd.) relative to 100 parts by mass of the silica powder D and 0.5 parts by mass of a silane coupling agent (KBM-403, manufactured by Shin-Etsu Silicones) relative to 100 parts by mass of the silica powder D were fed with use of a peristaltic pump (SJ-1211 II-H, manufactured by ATTA). After the above feed, stirring was continued, and mixing was carried out for 15 minutes. After the mixing, while the stirring was still continued, the temperature was increased from room temperature to 40° C. in 20 minutes. The temperature was then maintained at 40° C. for 60 minutes. Thereafter, the temperature was increased to 100° C. in 60 minutes, and was then maintained at 100° C. for 180 minutes, so that a reaction step was finished. After the reaction step was finished, cooling was carried out, and nitrogen was circulated in the vessel and drying was carried out while the temperature was maintained at 30° C. As a result, surface-treated silica powder was obtained. Physical properties of the surface-treated silica powder thus obtained were measured.

### Example 5

Surface-treated silica powder was prepared and measured as in Example 1, except that: silica powder E was used, instead of silica powder A; and 0.5 parts by mass of KBM-403 was used as the silane coupling agent, relative to 100 parts by mass of the silica powder E.

### Example 6

Surface-treated silica powder was prepared and measured as in Example 4, except that 0.01 parts by mass of hexamethyldisilazane (SZ-31, manufactured by Shin-Etsu Silicones) relative to 100 parts by mass of the silica powder D and 1.0 part by mass of a silane coupling agent (KBM-403, manufactured by Shin-Etsu Silicones) relative to 100 parts by mass of the silica powder D were used.

### Example 7

Surface-treated silica powder was prepared and measured as in Example 4, except that 0.01 parts by mass of hexamethyldisilazane (SZ-31, manufactured by Shin-Etsu Silicones) relative to 100 parts by mass of the silica powder D and 2.0 parts by mass of a silane coupling agent (KBM-403, manufactured by Shin-Etsu Silicones) relative to 100 parts by mass of the silica powder D were used.

### Example 8

Surface-treated silica powder was prepared and measured as in Example 1, except that: silica powder D was used, instead of silica powder A; and 0.5 parts by mass of a silane coupling agent (KBM-573, manufactured by Shin-Etsu Silicones) was used, relative to 100 parts by mass of the silica powder D.

### Example 9

Surface-treated silica powder was prepared and Surface-treated measured as in Example 4, except that 0.01 parts by mass of hexamethyldisilazane (SZ-31, manufactured by Shin-Etsu Silicones) relative to 100 parts by mass of the silica powder D and 0.5 parts by mass of a silane coupling agent (KBM-303, manufactured by Shin-Etsu Silicones) relative to 100 parts by mass of the silica powder D were used.

### Example 10

Surface-treated silica powder was prepared and measured as in Example 4, except that 0.01 parts by mass of hexamethyldisilazane (SZ-31, manufactured by Shin-Etsu Silicones) relative to 100 parts by mass of the silica powder D and 0.5 parts by mass of a silane coupling agent (KBM-503, manufactured by Shin-Etsu Silicones) relative to 100 parts by mass of the silica powder D were used.

### Example 11

Surface-treated silica powder was prepared and measured as in Example 4, except that 0.02 parts by mass of hexamethyldisilazane (SZ-31, manufactured by Shin-Etsu Silicones) relative to 100 parts by mass of the silica powder D and 0.5 parts by mass of a silane coupling agent (KBM-403, manufactured by Shin-Etsu Silicones) relative to 100 parts by mass of the silica powder D were used.

### Comparative Example 1

Surface-treated silica powder was prepared and measured as in Example 2, except that: no epoxysilane coupling agent was added; a heating treatment was carried out at 150° C.; and a drying treatment was carried out at 20 hPa and 50° C. for 1 hour.

### Comparative Example 2

Surface-treated silica powder was prepared and measured as in Example 1, except that: 0.75 parts by mass of a silane coupling agent (KBM-403, manufactured by Shin-Etsu Silicones) was used relative to 100 parts by mass of silica powder A; and a drying treatment was carried out at 20 hPa and 50° C. for 1 hour.

### Comparative Example 3

Surface-treated silica powder was prepared and measured as in Example 1, except that: 0.5 parts by mass of a silane coupling agent (KBM-403, manufactured by Shin-Etsu Silicones) was used relative to 100 parts by mass of silica powder A; and a drying treatment was carried out at 20 hPa and 50° C. for 1 hour.

### Comparative Example 4

Silica powder A was introduced into a mixing vessel, and stirring was started. Then, 0.5 parts by mass of a silane coupling agent (KBM-403, manufactured by Shin-Etsu Silicones) was fed to 100 parts by mass of the silica powder A with use of a peristaltic pump (SJ-1211 II-H, manufactured by ATTA CORPORATION). After the above feed, stirring was continued, and mixing was carried out for 15 minutes. After that, no reaction step by heating was carried out, and nitrogen was circulated in a reaction vessel to carry out drying. Then, a resultant surface-treated silica powder was measured.

### Comparative Example 5

Surface-treated silica powder was prepared and measured as in Example 1, except that 9 parts by mass of a silane coupling agent (KBM-403, manufactured by Shin-Etsu Silicones) was used relative to 100 parts by mass of silica powder A.

### Comparative Example 6

Surface-treated silica powder was prepared and measured as in Example 2, except that 18 parts by mass of a silane coupling agent (KBM-403, manufactured by Shin-Etsu Silicones) was used relative to 100 parts by mass of silica powder A.

In the surface-treated silica powder in each of Examples 1 to 11, the silane coupling agent component that was not chemically bonded was present in a large amount in addition to the chemically bonded silane coupling agent. Such surface-treated silica powder exhibited good results in terms of both the thickening index and the gap permeability. This can be said to be an advantageous effect resulting from shielding, by the silane coupling agent component, a resin from a reactive hydroxyl group on the silica particle surface. In Comparative Example 1 which had no silane coupling agent component and in Comparative Example 3 in which only a chemically bonded silane coupling agent component was present and the amount of the silane coupling agent component per specific surface area of silica particles present on the surface-treated silica powder was small, both of the thickening index and the gap permeability were poor. Furthermore, in the case of Comparative Example 2 in which the amount of a physically adsorbed silane coupling agent component was small, only the gap permeability was good. On the other hand, in both cases of Comparative Example 4 in which the amount, per specific surface area of the silica particles, of the silane coupling agent component present on the surface-treated silica powder was small and Comparative Example 5 in which such an amount of the silane coupling agent component was large, only the thickening index was good. In addition, the surface-treated silica powder in accordance with Comparative Example 6 having a V₉₀ of 100 or more exhibited, as a result, a low gap permeability.

1. Surface-treated silica powder obtained by subjecting silica particles to surface treatment with use of a silica coupling agent,
in a case where an amount, per specific surface area of the silica particles, of a silane coupling agent component chemically bonded to surfaces of the silica particles is C (molecules/nm²) and an amount, per specific surface area of the silica particles, of a silane coupling agent component present on the surface-treated silica powder is T (molecules/nm²), a ratio (C/T) of these silane coupling agent component amounts being 0.7 or less.

2. The surface-treated silica powder according to claim 1, wherein the amount T of the silane coupling agent component is 2.0 molecules/nm² to 22.0 molecules/nm².

3. The surface-treated silica powder according to claim 1, wherein an amount (V₉₀) of coarse particles of the surface-treated silica powder, which is obtained by expression 1 from a cumulative 50 volume % diameter (D₅₀) and a cumulative 90 volume % diameter (D₉₀) of a volume-based particle size distribution obtained by a laser diffraction scattering method, is 10 or more and less than 100:
$${V}_{90} = \{ ( {D}_{90} - {D}_{50} ) / {D}_{50} \} \times 100. \qquad ( 1 )$$

4. The surface-treated silica powder according to claim 1, having a BET specific surface area of 1 m²/g to 100 m²/g.

5. A resin composition obtained by dispersing, in a resin, the surface-treated silica powder according to claim 1.

6. A dispersion obtained by dispersing, in a solvent in liquid form, the surface-treated silica powder according to claim 1.
